(19) United States
(12) Patent Application Publication
(10) Pub. No.: US 2007/0199881 A1
(43) Pub. Date: Aug. 30, 2007

(54) Fuel Filter With Antifreeze Device

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., PORTO MANTOVANO (IT)

(21) Appl. No.: 11/629,871

(22) PCT Filed: Jul. 25, 2005
(86) PCT No.: PCT/EP05/08138

§ 371 Date: Dec. 18, 2006

(30) Foreign Application Priority Data
Aug. 3, 2004 (IT) RE2004A000099

(51) Int. Cl. B01D 27/00

(52) U.S. Cl. 210/384; 210/435; 210/416.4; 210/388

(57) ABSTRACT

A fuel filter (1) with antifreeze device comprising an outer casing (2), the interior (24) of which is separated by a filtering baffle (5) into two separate chambers (25, 26) to which a fuel inlet conduit (3) and a fuel outlet conduit (4) are connected respectively; said filter (1) comprises a device (6) for generating pressure waves within the casing (2), such that said pressure waves propagate at least through the fuel contained in the interior (24), so increasing its kinetic energy.

### TECHNICAL FIELD

The present invention relates in a general sense to a fuel filter for internal combustion engines, and in particular to a diesel fuel filter to be associated with diesel engines.

### PRIOR ART

Diesel engine fuel is known to normally contain impurities, because of which the diesel engine feed system has to be provided with a suitable fuel filter.

Modern diesel fuel filters generally consist of a cup-shaped body closed by a cover and containing a coaxial filter cartridge generally of toroidal shape.

Between the cartridge and the cup-shaped body there are defined two chambers for passage of the diesel fuel to be filtered and of the filtered diesel fuel respectively, the first connected to the pump unit and the second to the injection system.

The chamber for passage of the diesel fuel to be filtered is normally provided by the inner region of the filter cartridge.

In addition to said impurities, diesel fuel also generally contains waxy materials, such as paraffin, which tend to thicken at relatively low temperatures, of the order of −5° C., until they solidify at lower temperatures, of the order of −20/25° C.

Hence, if the engine remains inactive for a certain time at very low temperatures, said waxy materials such as paraffin separate from the diesel fuel and solidify, with consequent clogging of the filter, making it impossible to operate the engine.

### DISCLOSURE OF THE INVENTION

The object of the present invention is to overcome this type of drawback by providing a fuel filter fitted with a device for preventing or delaying paraffin aggregation.

For this purpose, filters are already known and currently used, provided with heating devices disposed within the chamber of the diesel fuel to be filtered. The purpose of said devices, which can also be of disposable or once-only use type, is to heat the diesel fuel present in said chamber, to raise it to a temperature such as to cause the paraffin to melt, at least at the moment of starting the engine.

The filter of the present invention proposes to solve the said technical problem without using any heat source, by a device able to effectively replace known heating devices.

Another object of the invention is to attain said object within the context of a simple, rational, reliable and economical construction of small overall size.

The invention attains said object by virtue of the characteristics defined in the claims.

Specifically, the invention provides a fuel filter with antifreeze device comprising an outer casing, the interior of which is separated by a filtering baffle into two separate chambers to which a fuel inlet conduit and a fuel outlet conduit are connected respectively; said filter further comprising a device for generating pressure waves within the outer casing, such that said pressure waves propagate at least through the fuel contained in the filter interior.

By this solution, the diesel fuel molecules contained in the filter, and with them the molecules of the waxy substances dissolved in it, are made to vibrate, so increasing their kinetic energy and hence preventing aggregation of the constituent paraffin long molecular chains.

In a preferred embodiment of the invention, said device is at least partly housed within the filter casing, inside the chamber of the diesel fuel to be filtered.

Specifically, in said embodiment the device is preferably removably associated with a hole provided in the filter cover, to present a portion contained within the chamber of the diesel fuel to be filtered, and a portion projecting to the outside.

By virtue of this solution, in addition to enabling the pressure waves to propagate through the diesel fuel contained in the filter, the device is made easily accessible, so simplifying mounting, replacement and maintenance operations.

According to the invention, the device comprises generator means for generating the pressure waves, and activation means for activating said generator means when the conditions (low temperature) requiring their use occur.

Said generator means can be of mechanical or electronic type; in the first case said means comprise an electric motor rotating an eccentric mass to produce a vibration which itself generates the pressure waves; in the second case said generator means comprise an ultrasound emitter, or alternatively a piezoelectric device, both being able to transform an electric pulse into a mechanical wave, although utilizing different operating principles,

With regard to the activation means, the invention again contemplates various embodiments.

In one of said embodiments, the activation means comprise a temperature sensor able to measure the temperature of the diesel fuel within the filter and to generate a corresponding electrical signal, and a processor for said signal which activates said generator means when a minimum temperature threshold value is attained, so making the operation of the device completely automatic.

In a second embodiment, which is conveniently very economical, said activation means instead comprise a switch, associated with the device, to be operated manually when said generator means are to be activated.

An improvement in this latter arrangement consists of using, instead of the manual switch, a remotely controlled switch which makes the device operable from a distance.

As the device requires a source of electrical energy for its operation, in a preferred embodiment of the invention said device comprises an electrical generator, in particular an alkaline battery; in this manner the device operation is completely independent and hence easy to manage. In another alternative embodiment the device is powered by the vehicle electrical system.

Finally, according to the invention, the device comprises an outer jacket for containing and housing said generator means, so protecting them from the high pressures which, present within the diesel fuel inlet chamber, could damage them.

Preferably said outer jacket also contains the activation means and, if present, also the electrical generator, so that the device represents a single unit which can be advantageously constructed independently of the filter and mounted thereon only afterwards, so facilitating its replacement and maintenance.

The dependent claims define particularly advantageous preferred embodiments of the fuel filter according to the invention.

### BRIEF DESCRIPTION OF THE DRAWINGS

Further characteristics and advantages of the invention will be apparent on reading the ensuing description provided by way of non-limiting example, with the aid of the figures shown in the accompanying drawings, in which:

FIG. 1 is a longitudinal section through a filter according to the invention;

FIG. 2 is a longitudinal section through a device in accordance with a first embodiment of the invention;

FIG. 3 is a longitudinal section through a device in accordance with a second embodiment of the invention;

FIG. 4 shows the device of FIG. 2 mounted in a manner conforming to a preferred embodiment of the invention;

### BEST MODE FOR CARRYING OUT THE INVENTION

Said figures show a diesel fuel filter 1 comprising an outer casing 2 provided with an inlet conduit 3 for the diesel fuel to be filtered and an outlet conduit 4 for the filtered diesel fuel.

The casing 2 comprises a cup-shaped body 20 closed by a cover 21.

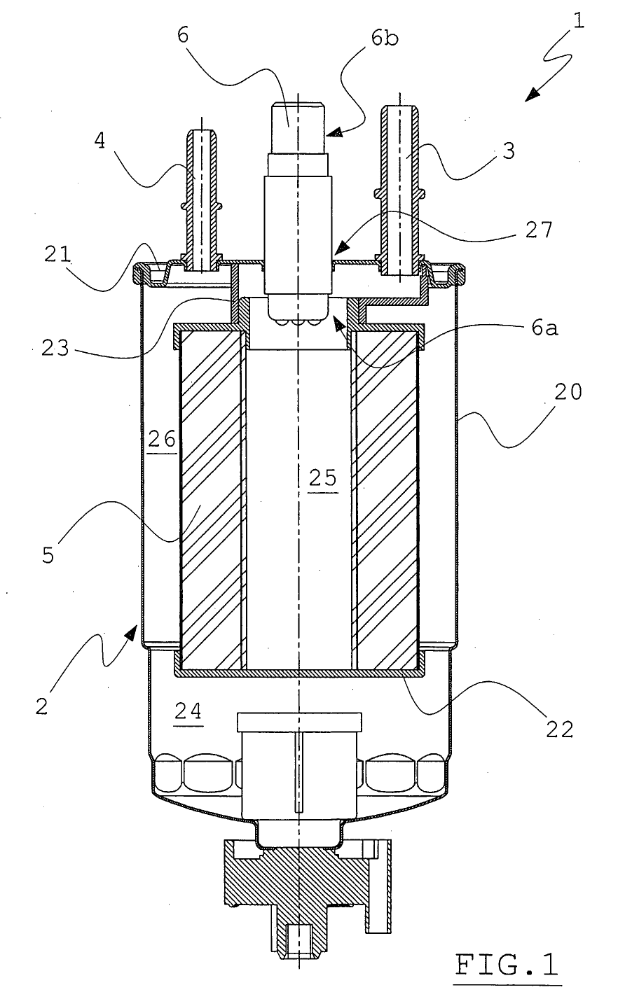

The interior of the casing 1 houses a toroidal filtering baffle 5, supported between a lower base 22 and an upper stub 23 which branches from the cover 21. Said filtering baffle 5 divides the interior 24 of the casing 1 into two separate chambers 25 and 26, of which the first, 25, is connected to the inlet conduit 3 for the diesel fuel to be filtered and the second, 26, to the outlet conduit 4 for the filtered diesel fuel (see FIG. 1).

The diesel fuel filter 1 also comprises a device 6 for generating, within the casing 2, pressure waves which propagate through the diesel fuel contained in the interior 24, so increasing its kinetic energy.

As can be seen from FIG. 1, to make this propagation possible, a part of the device 6 is housed within the casing 2, and specifically within the chamber 25 to which the inlet conduit 3 for the diesel fuel to be filtered is connected.

In detail (see FIG. 1), the device 6 is removably associated with the outer casing 2 by being inserted through a hole 27 provided in the cover 21, such as to present a portion 6a housed within said chamber 25 for the diesel fuel to be filtered, and a portion 6b projecting to the outside.

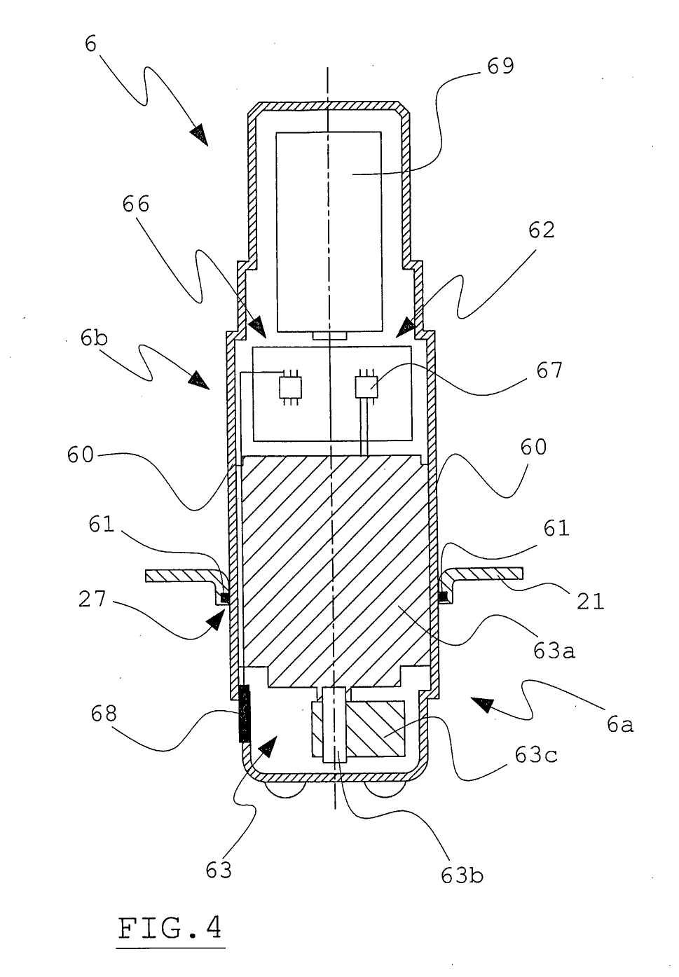

In a preferred embodiment of the invention (see FIG. 4), the device 6 is associated with the casing 2 by way of an interposed elastic element, in particular an elastic ring 61, so that the generated pressure waves propagate only through the diesel fuel, to prevent also vibrating the casing 2 and hence the entire structure of the filter 1.

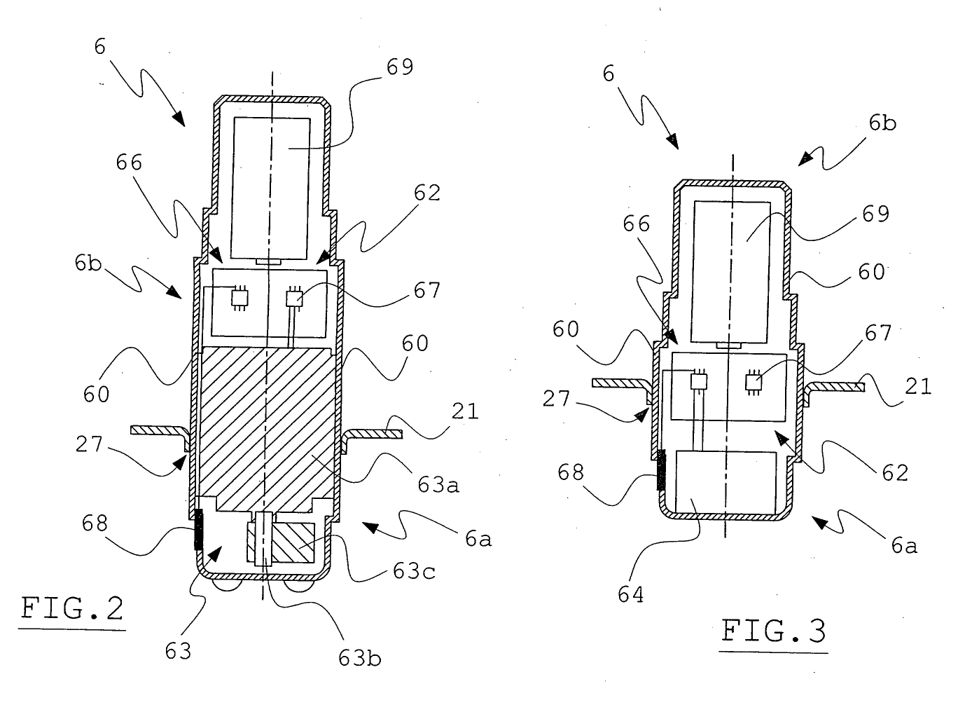

The device 6 (see FIGS. 2 and 3) comprises an outer jacket 60, of metal or polymer material, for containing generator means 63 or 64 for generating said pressure waves, activation means 62 for activating said generator means, and an electrical energy generator 69, in particular an alkaline battery, to power said generator means 63 or 64 and said activation means 62.

The generator means 63 or 64 are disposed within the outer jacket 60, specifically in correspondence with that portion 6a contained in the inlet chamber 25, such that the pressure waves generated thereby propagate through the interior 20 of the filter 1.

FIGS. 2 and 3 show two possible embodiments of said generator means: one 63 of mechanical type and the other 64 of electronic type.

FIG. 2 shows the embodiment of mechanical type, in which said generator means 63 comprise an electric motor 63a provided with a projecting rotary shaft 63b, and an eccentric mass 63c keyed onto said rotary shaft 63b and rotated by the motor 63a; on rotating, said eccentric mass 63c produces vibration of the device 6, which in its turn generates pressure waves.

FIG. 3 shows the embodiment of electronic type, in which said generator means comprise a piezoelectric device 64 which transforms an electric pulse into a mechanical pressure wave.

As can be seen from FIGS. 2 and 3, whatever their form, said generator means 63 or 64 are connected to the activation means 62 which activate them when the temperature of the diesel fuel within the filter 1 falls below a determined minimum threshold value dangerous for paraffin formation.

Said activation means 62 comprise a temperature sensor 66 arranged to measure the temperature of the diesel fuel within the filter 1 and to generate a corresponding electrical signal, and a processor 67 connected to said sensor 66 to activate the generator means 63 or 64 when said signal corresponds to said minimum threshold temperature value.

The temperature sensor 66 comprises a probe 68 fixed to the outer jacket 60 in the portion 6a contained within the inlet chamber 25, to hence measure the temperature of the diesel fuel present therein.

In use, the temperature sensor 66 continuously measures the temperature of the diesel fuel in the inlet chamber 25 by the probe 68, the temperature sensor 66 generating a corresponding electrical signal and transmitting it to the processor 67, said processor 67 being set to recognize when the electrical signal corresponds to a minimum threshold temperature value, below which there is a risk of paraffin formation (about −5° C.).

When the temperature falls below said minimum threshold value, the signal processor 67 activates the generator means 63 or 64.

In the embodiment shown in FIG. 2, the processor 67 activates the electric motor 63a which then rotates the eccentric mass 63c; whereas in the embodiment of FIG. 3, the processor 67 feeds electric pulses to the piezoelectric device 64, which transforms them into pressure waves.

Once operating, and while the temperature remains below the threshold value, the generator means 63 or 64 are controlled such that they operate cyclically, such as to generate pressure waves which, at determined intervals, vibrate the diesel fuel molecules, to increase their kinetic energy and delay aggregation of the long chain molecules which give rise to paraffins.

If the device 6 is mounted with the elastic ring 61 interposed, said pressure waves propagate only through the diesel fuel (see FIG. 4), whereas if the device is associated rigidly with the casing (see FIGS. 2 and 3) the pressure waves also vibrate the casing 3, however this does not create operating problems.

1. A fuel filter (1) with antifreeze device comprising an outer casing (2), the interior (24) of which is separated by a filtering baffle (5) into two separate chambers (25, 26) to which a fuel inlet conduit (3) and a fuel outlet conduit (4) are connected respectively, characterised by comprising a device (6) for generating pressure waves within the casing (2), such that said pressure waves propagate at least through the fuel contained in the interior (24), so increasing its kinetic energy.

2. A fuel filter (1) as claimed in claim 1, characterised in that at least a part (6a) of said device (6) is housed within said outer casing (2).

3. A fuel filter (1) as claimed in claim 2, characterised in that said at least a part (6a) of said device (6) housed within the casing (2) is positioned in the chamber (25) to which the fuel inlet conduit (3) is connected.

4. A fuel filter (1) as claimed in claim 2, characterised in that said device (6) is associated with the outer casing (2) in such a manner as to be partly inserted into the interior of said casing (2).

5. A fuel filter (1) as claimed in claim 4, characterised in that said device (6) is removably associated with the outer casing (2).

6. A fuel filter (1) as claimed in claim 1, characterised in that the outer casing (2) comprises a cup-shaped body (20) closed by a cover (21), said device (6) being associated with a hole (27) provided in said cover (21).

7. A fuel filter (1) as claimed in claim 4, characterised in that said device (6) is associated with the outer casing (2) by way of an interposed elastic element (61), so that the pressure waves propagate only through the fuel.

8. A fuel filter (1) as claimed in claim 4, characterised in that said device (6) is associated rigidly with the outer casing (2), so that the pressure waves cause the casing (2) to vibrate.

9. A fuel filter (1) as claimed in claim 1, characterised in that said device (6) comprises pressure wave generator means (63, 64), and activation means for activating said generator means (63, 64).

10. A fuel filter (1) as claimed in claim 9, characterised in that said generator means (63) comprise an electric motor (63a) and an eccentric mass (63c) which, when rotated by the motor (63a), produces vibration of the device (6), which in its turn generates pressure waves through the fuel.

11. A fuel filter (1) as claimed in claim 9, characterised in that said generator means comprise a piezoelectric device (64) arranged to transform an electric pulse into a mechanical pressure wave.

12. A fuel filter (1) as claimed in claim 9, characterised in that said generator means comprise an ultrasound emitter.

13. A fuel filter (1) as claimed in claim 9, characterised in that said activation means (62) comprise a temperature sensor (66) which measures the temperature of the fuel within the casing (2) and generates a corresponding electrical signal, and a processor (67) for said electrical signal, which activates the generator means (63, 64) when the temperature attains a minimum threshold value.

14. A fuel filter (1) as claimed in claim 9, characterised in that said activation means (62) comprise a manual switch associated with the device (6).

15. A fuel filter (1) as claimed in claim 9, characterised in that said activation means (62) comprise a remotely controlled switch.

16. A fuel filter (1) as claimed in claim 9, characterised in that said device (6) comprises an outer jacket (60) which houses said generator means (63, 64) in its interior and is at least partly inserted into the interior of the filter casing (2).

17. A fuel filter (1) as claimed in claim 16, characterised in that said outer jacket (60) houses said activation means (62) in its interior.

18. A fuel filter (1) as claimed in claim 9, characterised in that said device (6) comprises an electrical generator(69) for its powering.

19. A fuel filter (1) as claimed in claim 18, characterised in that said device (6) comprises an outer jacket (60) for housing in its interior said generator means (63, m64), said activation means (62) and said electrical generator (69); said outer jacket (60) being at least partly inserted into the interior of the filter casing (2).

20. A fuel filter (1) as claimed in claim 9, characterised in that said device (6) is powered by the battery of the vehicle on which the filter (1) is mounted.
